(19) United States
(12) Patent Application Publication
(10) Pub. No.: US 2025/0168250 A1
(43) Pub. Date: May 22, 2025

(54) INFORMATION PROCESSING SYSTEM, POSITION LOCATION METHOD, AND TERMINAL DEVICE

(71) Applicant: NEC Corporation, Tokyo (JP)

(72) Inventors: Yuki ASHINO, Tokyo (JP); Masahiro Karube, Tokyo (JP)

(73) Assignee: NEC Corporation, Tokyo (JP)

(21) Appl. No.: 18/941,192

(22) Filed: Nov. 8, 2024

(30) Foreign Application Priority Data
Nov. 17, 2023 (JP) 2023-195740

(51) Int. Cl. H04L 67/52; H04L 12/46; H04L 67/141

(52) U.S. Cl. CPC H04L 67/52; H04L 67/141; H04L 12/4641

(57) ABSTRACT

An address of each of three or more distance measurement devices, to which a communication packet of a target device is to be transmitted, is acquired. The distance between the target device and a distance measurement device is calculated, for each of the three or more distance measurement devices, based on a communication packet that the target device transmitted to the address of the distance measurement device. A location result for predicting a located position of the target device is generated based on positions of the three or more distance measurement devices and distances between the target device and the three or more distance measurement devices.

This application is based upon and claims the benefit of priority from Japanese patent application No. 2023-195740, filed Nov. 17, 2023, the disclose of which is incorporated herein in its entirety by reference.

### TECHNICAL FIELD

The present disclosure relates to an information processing system, a position location method, and a terminal device.

### BACKGROUND ART

Technology for locating the geographical position of a device associated with a specific internet protocol address is disclosed in Patent Document 1 (Japanese Unexamined Patent Application Publication No. 2018-521610).

### SUMMARY

Therefore, an example of an objective of the present disclosure is to provide an information processing system, a position location method, and a terminal device.

According to an example of a first embodiment disclosed herein, an information processing system is provided with acquiring means for acquiring an address of each of three or more distance measurement devices to which a communication packet of a target device is to be transmitted; distance calculating means for calculating, for each of the three or more distance measurement devices, a distance between the target device and a distance measurement device based on the communication packet that the target device transmitted to the address of the distance measurement device; locating means for generating a location result for predicting a located position of the target device based on positions of the three or more distance measurement devices and distances between the target device and the three or more distance measurement devices; and outputting means for outputting the location result.

According to an example of a second embodiment disclosed herein, a position location method involves acquiring an address of each of three or more distance measurement devices to which a communication packet of a target device is to be transmitted; calculating, for each of the three or more distance measurement devices, a distance between the target device and a distance measurement device based on the communication packet that the target device transmitted to the address of the distance measurement device; generating a location result for predicting a located position of the target device based on positions of the three or more distance measurement devices and distances between the target device and the three or more distance measurement devices; and outputting the location result.

According to an example of a third embodiment disclosed herein, a terminal device is provided with acquiring means for acquiring an address of each of three or more distance measurement devices to which a communication packet is to be transmitted; distance calculating means for calculating, for each of the three or more distance measurement devices, a distance between the target device and a distance measurement device based on the communication packet that the terminal device transmitted to the address of the distance measurement device; locating means for generating a location result for predicting a located position of the target device based on positions of the three or more distance measurement devices and distances between the target device and the three or more distance measurement devices; and outputting means for outputting the location result.

### BRIEF DESCRIPTION OF THE DRAWINGS

FIG. 1 is a block diagram illustrating a first configuration of an information processing system according to an example embodiment disclosed herein.

FIG. 2 is a diagram illustrating a summary of processing in the information processing system according to an example embodiment disclosed herein.

FIG. 3 is a diagram illustrating a first example of a distance calculation method according to an example embodiment disclosed herein.

FIG. 4 is a diagram illustrating a second example of a distance calculation method according to an example embodiment disclosed herein.

FIG. 5 is a block diagram illustrating a second configuration of the information processing system according to an example embodiment disclosed herein.

FIG. 6 is a diagram illustrating the processing flow in the information processing system according to an example embodiment disclosed herein.

FIG. 7 is a block diagram illustrating a third configuration of the information processing system according to an example embodiment disclosed herein.

FIG. 8 is a block diagram illustrating a fourth configuration of the information processing system according to an example embodiment disclosed herein.

FIG. 9 is a hardware configuration diagram of an information processing device according to an example embodiment disclosed herein.

FIG. 10 is a diagram illustrating another configuration of an information processing system according to an example embodiment disclosed herein.

FIG. 11 is a diagram illustrating another processing flow in an information processing system according to an example embodiment disclosed herein.

### EXAMPLE EMBODIMENTS

Hereinafter, an information processing system according to an example embodiment disclosed herein will be explained with reference to the drawings.

### First Example Embodiment

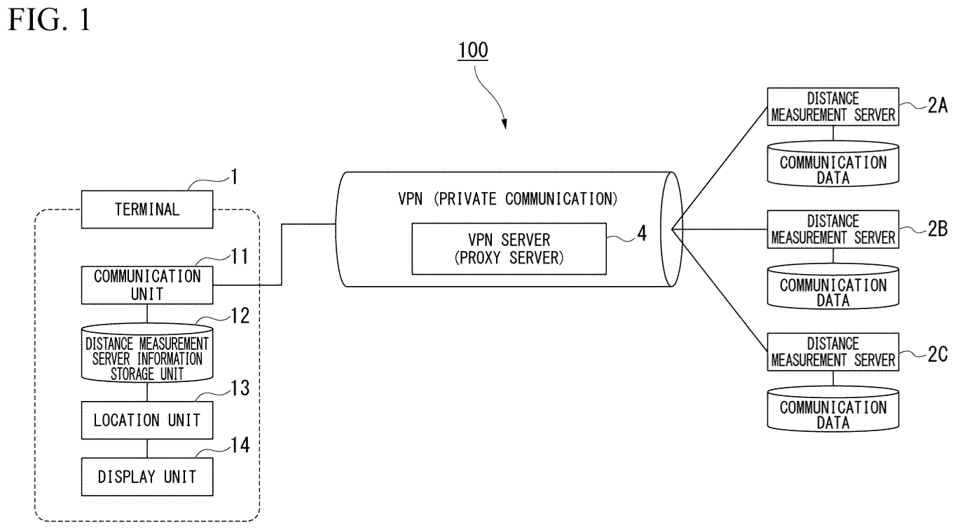

FIG. 1 is a block diagram illustrating a first configuration of an information processing system according to an embodiment disclosed herein. As illustrated in this drawing, the information processing system 100 is composed of a terminal 1 and distance measurement servers 2A, 2B, 2C. When referring to the respective distance measurement servers 2A, 2B, 2C in a general manner, they will be referred to as distance measurement servers 2. The terminal 1 and the distance measurement servers 2 are communicably connected, as an example, by private communication such as by a VPN (Virtual Private Network). The VPN may be provided with a VPN server 4 and may mediate communications between the terminal 1 and the distance measurement servers 2. The VPN server 4 may have the function of a proxy server or may lack the function of a proxy server. The terminal 1 is an example of a target device for which the physical position is to be measured. The distance measurement servers 2 are examples of distance measurement devices. At least three of the distance measurement servers 2 are communicably connected to the internet in a state in which communication with the terminal 1 is possible.

The terminal 1 provides the functions of a communication unit 11, a distance measurement server information storage unit 12, a location unit 13, and a display unit 14. These functions are functions provided in the terminal 1 by executing programs dedicated thereto.

The communication unit 11 communicates with the distance measurement servers 2.

The distance measurement server information storage unit 12 stores information on the IP addresses and the physical positions (latitude, longitude) of the distance measurement servers 2.

The location unit 13 calculates, for each of the three or more distance measurement servers 2, the distances between the distance measurement servers 2 and the terminal 1 based on communication packets transmitted respectively to the distance measurement servers 2, and generates location results for predicting a located position of the target device based on those distances and the positions of the distance measurement devices.

The display unit 14 outputs the location results.

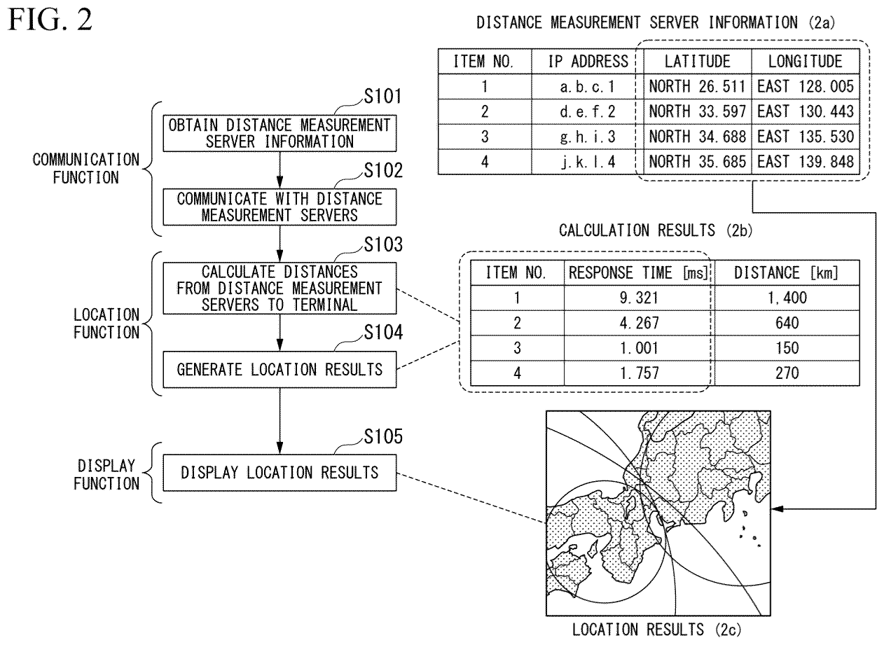

FIG. 2 is a diagram illustrating a summary of the processing in an information processing system according to an embodiment disclosed herein.

Next, the processing flow in the information processing system will be explained.

A user of the terminal 1 issues an instruction for a location request to the terminal 1 for checking how the physical position of the terminal 1, which connects to the internet, is understood by others. The terminal 1 acquires the instruction for the location request from the user. As one specific example, suppose that the terminal 1 uses web functions to access a prescribed device, such as a certain distance measurement server 2, and a location request button or the like is provided on a webpage that the terminal 1 has received from said device. By pressing the location request button or the like on the webpage displayed on a monitor on the terminal 1, the user issues an instruction for a location request to the terminal 1. Alternatively, a location request button or the like is provided in screen data output to the monitor when the terminal 1 starts a dedicated application, and an instruction for a location request is issued to the terminal 1 by the user pressing this location request button or the like. Upon detecting the location request for which an instruction was input by the user, the terminal 1 transmits a server information transmission request to a distance measurement server 2. The terminal 1 merely requires to transmit the server information transmission request to any one of the distance measurement servers 2 among multiple distance measurement servers 2. The distance measurement server 2 that has received the transmission request transmits prestored server information for the three or more distance measurement servers 2 to the terminal 1. The terminal 1 receives the server information and records it in a distance measurement server information storage unit 12 (step S101), as illustrated in FIG. 2 (2a). An example of server information, as illustrated in FIG. 2, is composed of an item number, an IP address, a latitude, a longitude, etc. for each of three distance measurement servers 2.

The communication unit 11 in the terminal 1, upon acquiring the server information of the distance measurement servers 2, uses IP addresses in the server information to communicate with the respective distance measurement servers (step S102). At this time, the communication unit 11 in the terminal 1 uses the information included in the server information to automatically establish VPN connections with the respective distance measurement servers 2. Furthermore, the communication unit 11 in the terminal 1, after establishing three-way handshakes of TCP connections with the distance measurement servers 2, transmits a GET for HTML data and receives the HTML data, thereby establishing communication. The communication unit 11 in the terminal 1 stores communication packets of the communication with the respective distance measurement servers 2.

The location unit 13 in the terminal 1, upon detecting that prescribed communications have been completed to the point that the communication unit 11 can receive HTML data or the like, starts locating the physical position of the terminal 1. When establishing VPN connections with the respective distance measurement servers 2, the location unit 13 in the terminal 1 checks the local proxy settings. This function of the location unit 13 is one mode for providing proxy setting detecting means for detecting whether or not a proxy has been locally set. The information regarding whether a proxy has been set can be obtained by referencing a prescribed information-containing file stored locally. For VPN connections between the terminal 1 and the distance measurement servers 2, there are cases in which a proxy server is provided between the VPN connections. In this case, a proxy has been set for the terminal 1. The proxy settings may be information that is set locally when the terminal 1 establishes the VPN connections with the distance measurement servers 2. The terminal 1 switches the method for calculating the physical distances between the terminal 1 and the distance measurement servers 2 in accordance with whether or not a proxy has been set for the VPN connections with the distance measurement servers 2.

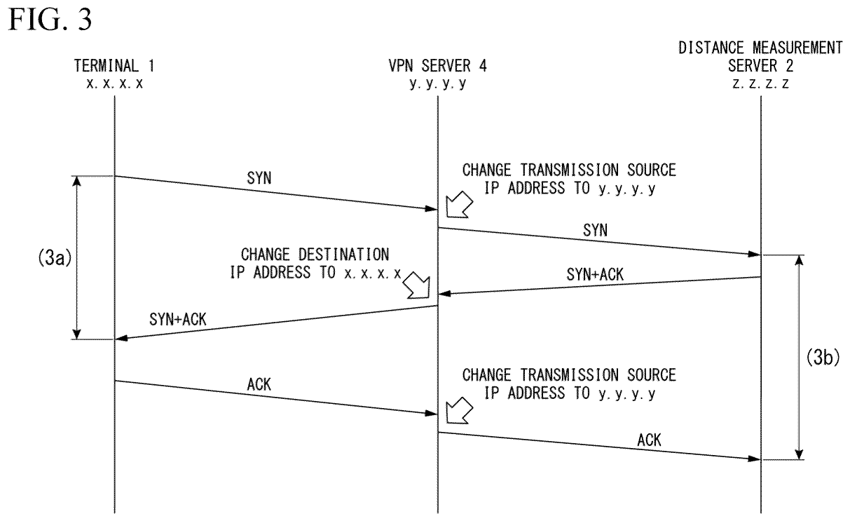

FIG. 3 is a diagram illustrating a first example of a distance calculation method according to an example embodiment disclosed herein.

When a proxy has not been set, the location unit 13 in the terminal 1 identifies, in communications for establishing a TCP connection as illustrated in FIG. 3, the time (3a) between the transmission timing of a SYN packet and the reception timing of a SYN+ACK packet received in response to that SYN packet, and the speed with which communication packets pass through the communication medium (optical fiber, etc.) communicably connecting the terminal 1 with a distance measurement server 2. The location unit 13 uses this information to calculate the distance from the distance measurement server 2 to the terminal 1 by means of the computational expression, distance=speed×time (step S103). Since the VPN server 4 is not provided with the function of a proxy server, the distance between the distance measurement server 2 and the terminal 1 can be estimated by communication packets making the roundtrip between the terminal 1 and the distance measurement server 2.

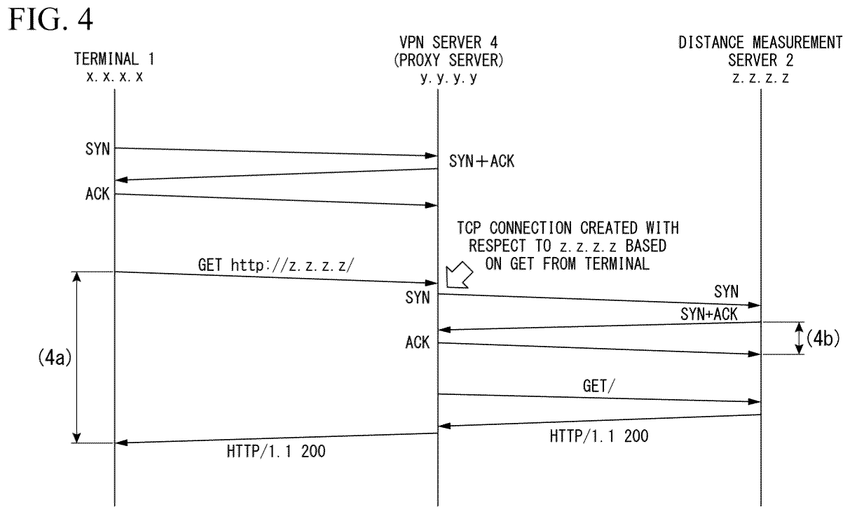

FIG. 4 is a diagram illustrating a second example of a distance calculation method according to an example embodiment disclosed herein.

When a proxy has been set, the location unit 13 in the terminal 1 calculates the distance by using, among the communication packets illustrated in FIG. 4, the other communication packets excluding the communication packets making the roundtrip between the terminal 1 and the proxy server. As one example, the time (4a) between the transmission timing of a communication packet including a GET command in TCP and the reception timing of a response packet by which HTTP data is received, and the speed with which communication packets pass through the communication medium (optical fiber, etc.) communicably connecting the terminal 1 with a distance measurement server 2 are identified. The location unit 13 in the terminal 1 uses this information to calculate the distance from the distance measurement server 2 to the terminal 1 by means of the computational expression, distance=speed×time (step S103). Since the VPN server 4 is provided with the function of a proxy server, the distance between the distance measurement server 2 and the terminal 1 can be estimated by using communication packets making the roundtrip between the terminal 1 and the distance measurement server 2.

Upon calculating the distances between the respective distance measurement servers 2 and the terminal 1, the location unit 13 in the terminal 1 reads the physical positions (latitude, longitude) of the respective distance measurement servers 2 from the distance measurement server information. The location unit 13, based on the physical positions (latitude, longitude) of the distance measurement servers 2 and the distances calculated for those distance measurement servers 2, generates location results data in which circles are drawn on a map, the circles being centered at the physical positions (latitude, longitude) of the distance measurement servers 2 and having radii equal to the distances between the terminal 1 and the corresponding distance measurement servers 2 (step S104). The location unit 13 outputs the location results to the display unit 14. The display unit 14 outputs the location results to a monitor or the like (step S105).

The location results generated in this way, as illustrated in the location results (2c) in FIG. 2, are map data in which, for the respective distance measurement servers 2, circles having radii equal to the distances between the terminal 1 and the distance measurement servers 2 are drawn on the map. The location unit 13 may generate location results (map data) displaying, in a highlighted manner, the range of overlap between the multiple circles centered at the physical positions of the respective distance measurement servers 2 and having radii equal to the distances between the terminal 1 and the distance measurement servers 2. The physical position of the terminal 1 can be estimated to be near the range displayed in a highlighted manner.

### Second Example Embodiment

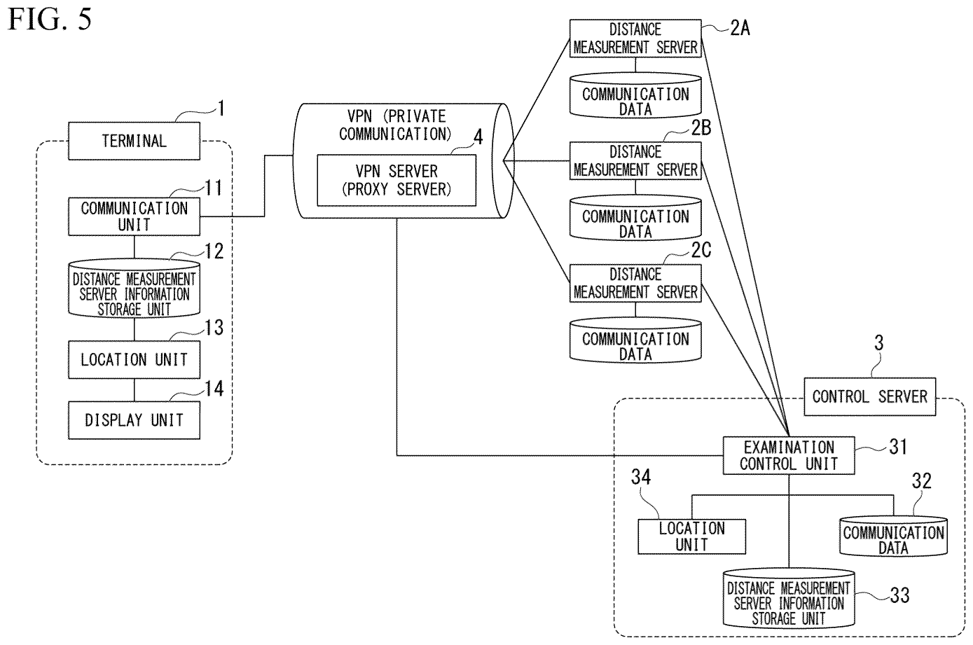

FIG. 5 is a block diagram illustrating a second configuration of the information processing system according to an example embodiment disclosed herein. As illustrated in FIG. 5, the information processing system may be provided with a control server 3. The control server 3 communicably connects with the respective distance measurement servers 2. The control server 3 generates location results instead of the terminal 1.

In this case, the control server 3 provides the functions of an examination control unit 31, a communication data storage unit 32, a distance measurement server information storage unit 33, and a location unit 34. These functions are provided in the control server 3 by the control server 3 starting prescribed programs.

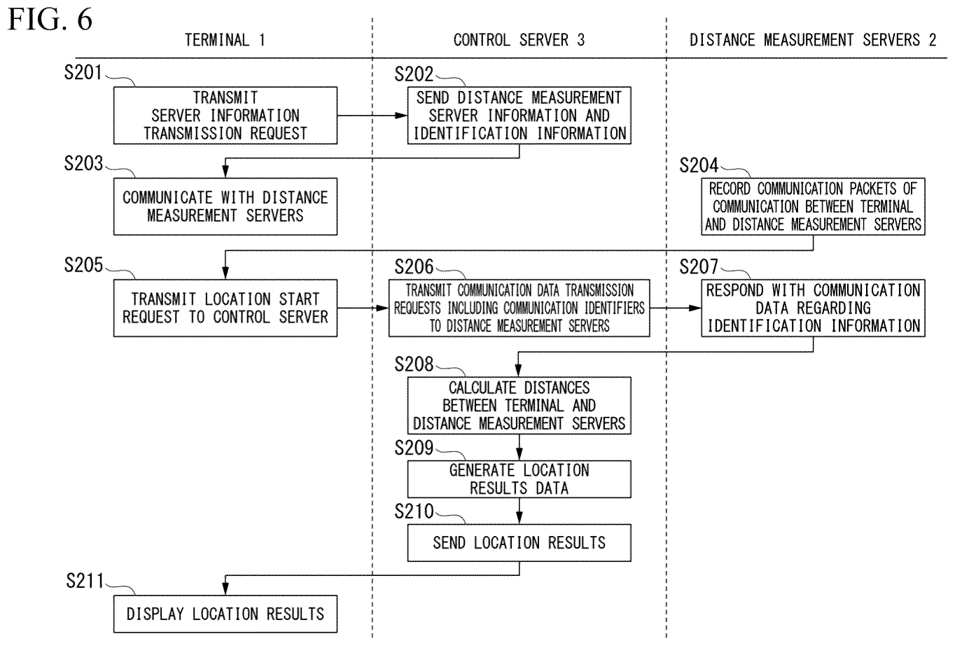

FIG. 6 is a diagram illustrating the processing flow in the information processing system according to an example embodiment disclosed herein. A user of the terminal 1 issues an instruction for a location request to the terminal 1 for checking how the physical position of the terminal 1, which connects to the internet, is understood by others. The terminal 1 acquires the instruction for the location request from the user. As one specific example, suppose that the terminal 1 uses web functions to access the control server 3, and a location request button or the like is provided on a webpage that the terminal 1 has received from said control server 3. By pressing the location request button or the like on the webpage displayed on a monitor on the terminal 1, the user issues an instruction for a location request to the terminal 1. Alternatively, a location request button or the like is provided in display data output to a monitor when the terminal 1 starts a dedicated application, and an instruction for a location request is issued to the terminal 1 by the user pressing this location request button or the like. Upon detecting the location request for which the instruction was input by the user, the terminal 1 transmits a server information transmission request to the control server 3 (step S201). The control server 3 that has received the transmission request transmits prestored server information for three or more distance measurement servers 2 and communication identification information (identifiers) to the terminal 1 (step S202). The server information, as illustrated in FIG. 2 (2a), is composed of an item number, an IP address, a latitude, a longitude, etc. for each of the three or more distance measurement servers 2. The terminal 1 receives the server information and records it in a distance measurement server information storage unit 12, as illustrated in FIG. 2 (2a).

The communication unit 11 in the terminal 1, upon acquiring the server information of the distance measurement servers 2, uses IP addresses included in the server information to communicate with the respective distance measurement servers (step S203). At this time, the communication unit 11 in the terminal 1 uses the information included in the server information to automatically establish VPN connections with the respective distance measurement servers 2. Furthermore, the communication unit 11 in the terminal 1, after establishing three-way handshakes of TCP connections with the distance measurement servers 2, transmits GETs for HTML data and receives the HTML data, thereby establishing communication. During this communication, the communication unit 11 in the terminal 1 inserts the identifiers acquired from the control server 3, as payloads, in the respective communication packets. The respective distance measurement servers 2 record communication packets of the communications between the terminal 1 and the respective distance measurement servers 2 in local communication data storage units (step S204).

The location unit 13 in the terminal 1, upon detecting that prescribed communications have been completed to the point that the communication unit 11 can receive HTML data or the like, transmits a location start request to the control server 3 (step S205). The location unit 13 inserts, in the location start request, the identifiers appended to the payloads of the communication packets in the communications between the terminal 1 and the distance measurement servers 2. The examination control unit 31 in the control server 3 acquires the location start request transmitted by the terminal 1. The examination control unit 31 transmits, to the respective distance measurement servers 2, communication data transmission requests including the communication identifiers included in the location start request (step S206). The control server 3 prestores the IP addresses of the respective distance measurement servers 2.

The respective distance measurement servers 2 use the communication identifiers included in the communication data transmission requests to identify communication data recorded in the communication data storage units. As a result thereof, even if the VPN server 4 has rewritten the IP addresses to a local IP address when transferring the communication packets to the distance measurement servers 2, the communications between the terminal 1 and the distance measurement servers 2 can be identified. The respective distance measurement servers 2 transmit the identified communication data to the control server 3 (step S207). The control server 3 receives, from the respective distance measurement servers 2, communication data between the terminal 1 and the distance measurement servers 2. The examination control unit 31 associates the IDs of the distance measurement servers 2 with the communication data and records these data in the communication data storage unit 32. As a result thereof, the control server 3 can perform location processes by utilizing communication data, which are groups of communication packets between the terminal 1 and the distance measurement servers 2.

In the VPN connections between the terminal 1 and the distance measurement servers 2, there are cases in which a proxy server is provided between the VPN connections. The control server 3 switches the method for calculating the physical distances between the terminal 1 and the distance measurement servers 2 in accordance with whether or not a proxy has been set for the VPN connections between the terminal 1 and the distance measurement servers 2. The control server 3 queries the respective distance measurement servers 2 regarding the proxy settings that are set, and receives proxy setting information. The control server 3 may acquire proxy settings (information indicating whether a proxy has or has not been set) for the respective distance measurement servers 2 from the respective distance measurement servers together with the communication data.

When a proxy has not been set for a target distance measurement server 2, the location unit 34 in the control server 3 identifies, in communications for establishing a TCP connection as illustrated in FIG. 3, the time ((3b) in FIG. 3) between the reception timing of a SYN packet (the generation timing of a SYN+ACK communication packet) and the reception timing of an ACK packet received from the terminal 1 in response to the transmission of the SYN+ACK packet, and the speed with which communication packets pass through the communication medium (optical fiber, etc.) communicably connecting the terminal 1 with the distance measurement server 2. The location unit 34 uses this information to calculate the distance from the terminal 1 to the distance measurement server 2 by means of the computational expression, distance=speed×time (step S208).

In this case, even if the VPN server 4 is not provided with the functions of a proxy server, the VPN server 4 changes the transmission source IP addresses of communication packets received from the terminal 1 to a local IP address. Therefore, from the communication packets received by the distance measurement server 2, only communication with the VPN server 4, and not the terminal 1, can be recognized. However, the distance between the terminal 1 and the distance measurement server can be calculated by using, in communications for establishing a TCP connection as illustrated in FIG. 3, the reception timing of a SYN packet (the generation timing of a SYN+ACK communication packet) and the reception timing of an ACK packet received from the terminal 1 in response to the transmission of the SYN+ACK packet.

When a proxy has not been set for a target distance measurement server 2, the location unit 34 in the control server 3 identifies, among communication packets as illustrated in FIG. 4, the transmission timing of a SYN+ACK packet transmitted by the distance measurement server 2 based on a SYN packet transmitted from the proxy, and the reception timing of an ACK packet received from the proxy in response thereto. The location unit 34 identifies a time (4b) based on these timings, and the speed with which communication packets pass through the communication medium (optical fiber, etc.) communicably connecting the proxy server with the distance measurement server 2. The location unit 34 uses this information to calculate the distance from the distance measurement server 2 to the proxy server by means of the computational expression, distance=speed×time (step S208).

In this case, even if the VPN server 4 is provided with the functions of a proxy server, the VPN server 4 changes the transmission source IP addresses of communication packets received from the terminal 1 to a local IP address. Therefore, from the communication packets received by the distance measurement server 2, only communication with the VPN server 4, and not the terminal 1, can be recognized. Therefore, in the case in which a proxy has been set, the distance between the terminal 1 and the proxy server can be calculated, as illustrated in FIG. 4, by using the transmission timing of a SYN+ACK packet transmitted by the distance measurement server 2 based on a SYN packet transmitted from the proxy, and the reception timing of an ACK packet received from the proxy server in response thereto. In this case, the terminal 1 would be understood, by a third party, to be at the position of the proxy server on the internet.

As illustrated in FIG. 3 and FIG. 4, the terminal 1, the distance measurement servers 2 and the VPN server 4 require some time from reception of a communication packet (for example, SYN or SYN+ACK) until a response (for example, SYN+ACK or ACK) to that communication packet is returned. This time fluctuates depending on the loads and the capacities of the respective devices. The location unit 13 in the terminal 1 and the location unit 34 in the control server 3 may perform processes for estimating, according to this time, the model types, the capacity types, the current communication fees, etc. of the terminal 1 and the VPN server 4 communicating with the distance measurement servers 2.

Upon calculating the distances between the terminal 1 and the respective distance measurement servers 2, the location unit 34 in the control server 3 reads the physical positions (latitude, longitude) of the respective distance measurement servers 2 from the distance measurement server information. The location unit 34, based on the physical positions (latitude, longitude) of the distance measurement servers 2 and the distances calculated for those distance measurement servers 2, generates location results data in which circles are drawn on a map, the circles being centered at the physical positions (latitude, longitude) of the distance measurement servers 2 and having radii equal to the distances between the terminal 1 and those distance measurement servers 2 (step S209). The location unit 34 outputs the location results to the terminal 1 (step S210). A display unit 14 in the terminal 1 outputs the location results to a monitor or the like (step S211).

The location results generated in this way, as illustrated in the location results (2c) in FIG. 2, are map data in which, for the respective distance measurement servers 2, circles having radii equal to the distances between the terminal 1 and the distance measurement servers 2 are drawn on the map. The location unit 34 may generate location results (map data) displaying, in a highlighted manner, the range of overlap between the multiple circles centered at the physical positions of the respective distance measurement servers 2 and having radii equal to the distances between the terminal 1 and the distance measurement servers 2. The physical position of the terminal 1 can be estimated to be near the range displayed in a highlighted manner.

### Third Example Embodiment

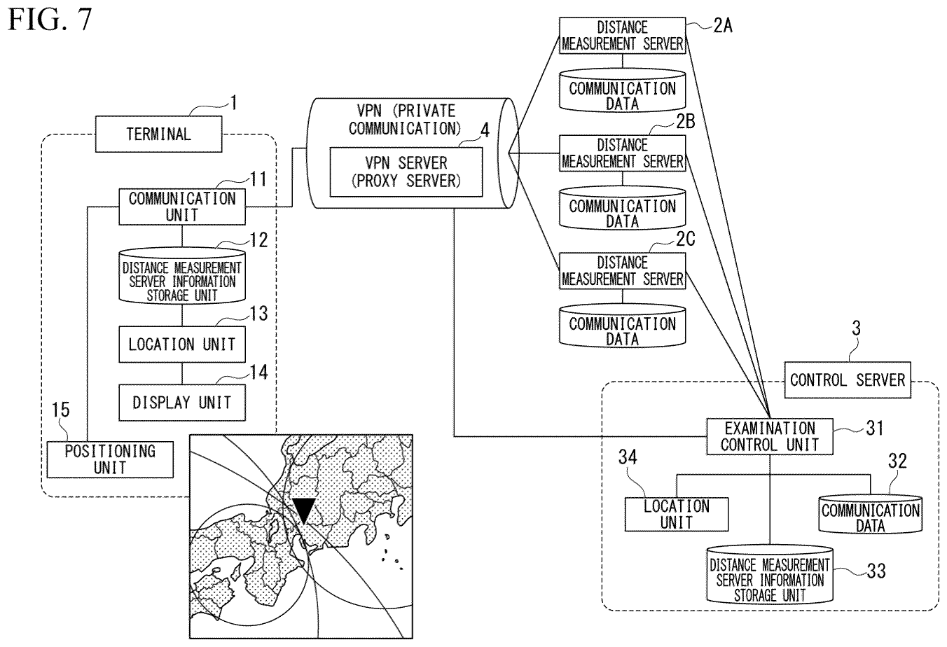

FIG. 7 is a block diagram illustrating a third configuration of the information processing system according to an example embodiment disclosed herein. As illustrated in FIG. 7, the terminal 1 may be provided with the functions of a positioning unit 15. The positioning unit 15 is, for example, a GPS sensor, and detects the physical position (latitude, longitude) of the terminal 1. The location unit 13 in the terminal 1 may process the location results so as to plot and display the physical position (latitude, longitude) of the terminal 1 detected by the positioning unit 15 in the map data indicated by the location results. As a result thereof, it is possible to output map data representing both the located position of the terminal 1 indicating the location results generated by the location unit 13 in the terminal 1 or the location unit 34 in the control server 3, and the physical position detected by the positioning unit 15 in the terminal 1.

### Fourth Example Embodiment

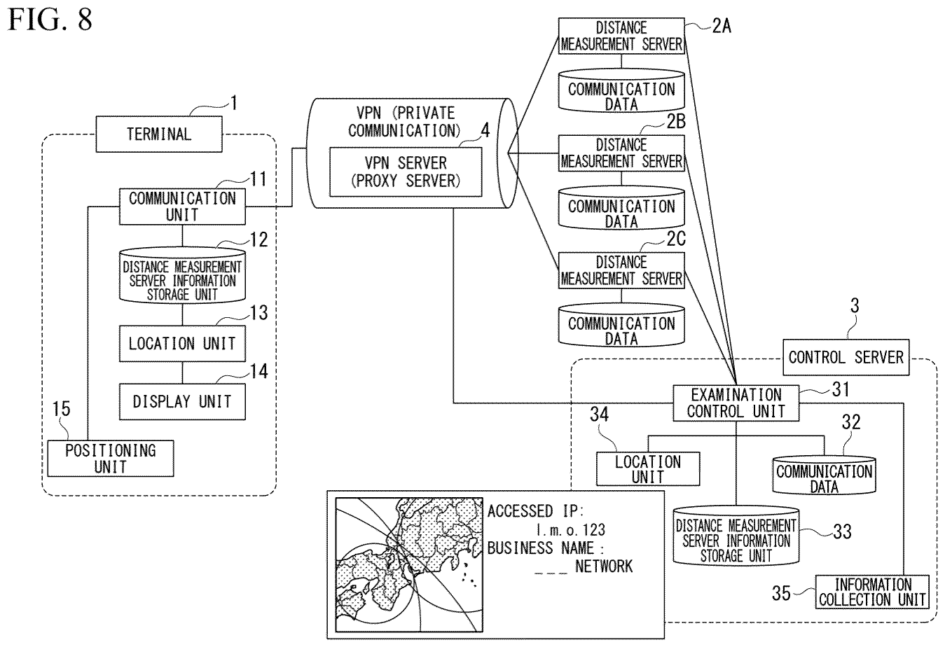

FIG. 8 is a block diagram illustrating a fourth configuration of the information processing system according to an example embodiment disclosed herein. As illustrated in FIG. 8, the control server 3 may be provided with the functions of an information collection unit 35. The information collection unit 35, when the examination control unit 31 has received communication data identified by the respective distance measurement servers 2 based on a location start request from the terminal 1, identifies the IP address of a VPN server 4 that can be recognized by the respective distance measurement servers 2 from the communication packets included in the communication data. The information collection unit 35 utilizes the IP address to acquire Whois information and includes the Whois information in the location results. The Whois information may be acquired by the control server 3 sending, over the internet, a command to acquire prescribed Whois information.

As described above, according to the information processing system disclosed herein, a user or the like utilizing the terminal 1, which is connected to the internet, can easily provide notification of location results indicating how the physical position of the terminal 1 was located by a third party.

The above-mentioned devices have internal computer systems. Furthermore, programs for making the respective devices perform the respective above-mentioned processes are stored on computer-readable recording media in said respective devices, and these programs are read out and executed by the computers in the respective devices to perform the above-mentioned processes. In this case, the computer-readable recording media refer to magnetic discs, magneto-optic discs, CD-ROMs, DVD-ROMs, semiconductor memory, etc. Additionally, these computer programs may be distributed to computers by means of communication lines, and the computers that have received the distributed programs may execute said programs.

Additionally, the above-mentioned programs may be for realizing just some of the functions of the respective above-mentioned processing units. Furthermore, they may be so-called difference files (difference programs) that can realize the aforementioned functions in combination with programs already recorded on a computer system.

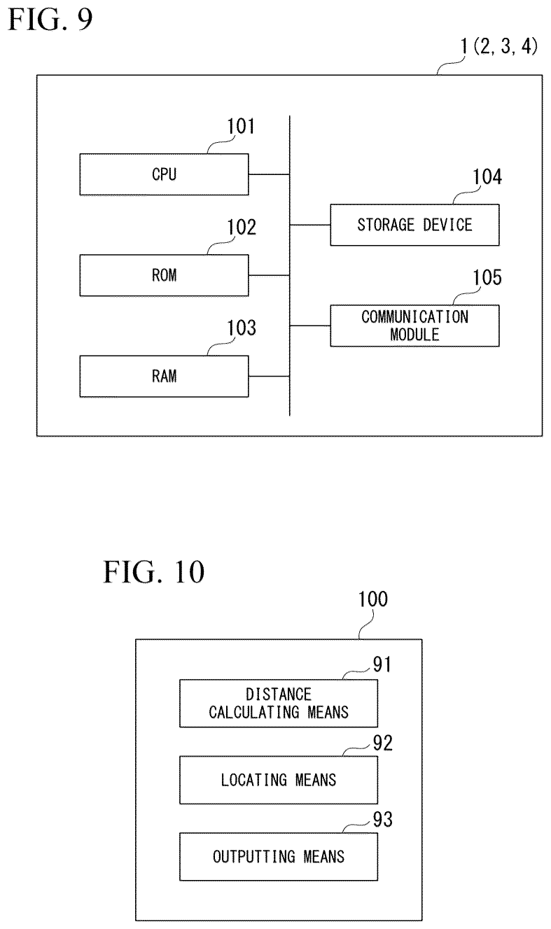

FIG. 9 is a hardware configuration diagram of an information processing device according to an example embodiment disclosed herein.

As illustrated in FIG. 9, the respective information processing devices disclosed herein, such as the terminal 1, the distance measurement servers 2, the control server 3 and the VPN server 4, are computers provided with hardware such as a CPU (Central Processing Unit) 101, a ROM (Read-Only Memory) 102, RAM (Random Access Memory) 103, another storage device 104, and a communication module 105.

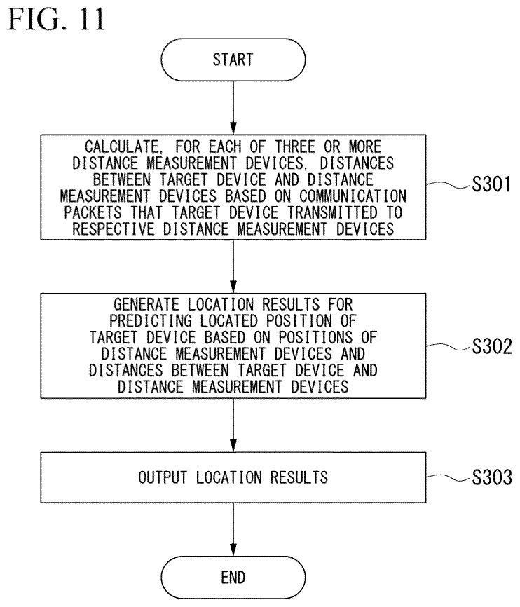

FIG. 10 is a diagram illustrating another configuration of an information processing system according to an example embodiment disclosed herein. FIG. 11 is a diagram illustrating another processing flow in an information processing system according to an example embodiment disclosed herein.

The information processing system 100, as illustrated in FIG. 10, is provided with at least a distance calculating means 91, a locating means 82 and an outputting means 93.

The distance calculating means 91 calculates, for each of three or more distance measurement devices, the distance between the distance measurement device and a target device based on communication packets transmitted by the target device to the respective distance measurement devices.

The locating means 92 generates location results for predicting the located position of the target device based on the positions of the distance measurement devices and the distances between the target device and the distance measurement devices.

The outputting means 93 outputs the location results.

While the information processing system 100 disclosed herein has been explained above, the present disclosure is not limited to the above-mentioned example embodiments. Various modifications that can be understood by a person skilled in the art can be made to the configurations and the details disclosed herein within the scope of the present disclosure.

As mentioned above, technologies for estimating the geographical positions of devices associated with specific internet protocol addresses are disclosed.

Therefore, for example, a technology is desired that can easily notify a user or the like utilizing a target device connected to the internet of how the geographical position of said target device is understood by a third party.

According to the present disclosure, for example, a user or the like utilizing a target device connected to the internet can be easily notified of how the geographical position of said target device is understood by a third party.

Some or all of the example embodiments described above may be described as appended below. However, the possible example embodiments are not limited to those indicated below.

### (Supplementary Note 1)

An information processing system comprising:
acquiring means for acquiring an address of each of three or more distance measurement devices to which a communication packet of a target device is to be transmitted;
distance calculating means for calculating, for each of the three or more distance measurement devices, a distance between the target device and a distance measurement device based on the communication packet that the target device transmitted to the address of the distance measurement device;
locating means for generating a location result for predicting a located position of the target device based on positions of the three or more distance measurement devices and distances between the target device and the three or more distance measurement devices; and outputting means for outputting the location result.

### (Supplementary Note 2)

The information processing system according to supplementary note 1, further comprising
proxy setting detecting means for detecting whether or not a proxy has been set for the target device, wherein:
the distance calculating means transmits communication packet to each of the three or more distance measurement devices based on respective IP addresses of the three or more distance measurement devices;
the distance calculating means, if the proxy has not been set, estimates the distance between the target device and the distance measurement device by using, among transmitted communication packets, a transmission timing of a SYN packet for establishing TCP connection and a reception timing of a SYN-ACK packet responding the SYN packet, and a position of the distance measurement device; and
the distance calculating means, if the proxy has been set, estimates the distance between the target device and the distance measurement device by using, among transmitted communication packets, a transmission timing of a communication packet other than that for establishing TCP connection and a reception timing of communication packet responding the communication packet, and the position of the distance measurement device.

### (Supplementary Note 3)

The information processing system according to supplementary note 1, wherein
the distance calculating means estimates, for each of the three or more distance measurement devices, the distance between the target device and the distance measurement device based on communication packets transmitted and received by the distance measurement device in communication by the communication packet transmitted by the target device to the distance measurement device.

### (Supplementary Note 4)

The information processing system according to supplementary note 3, further comprising
notifying means, by the target device, for inserting, into the communication packet, an identifier for identifying communication of the communication packet, and for transmitting the communication packet;
wherein the distance calculating means estimates, for each of the three or more distance measurement devices, the distance between the target device and the distance measurement device based on multiple communication packets identified based on the identifier transmitted and received by the distance measurement device.

### (Supplementary Note 5)

The information processing system according to any one of supplementary note 1 to supplementary note 4, further comprising
Whois information acquiring means for acquiring Whois information based on an IP address indicated by the communication packet;
wherein the outputting means outputs the Whois information.

### (Supplementary Note 6)

The information processing system according to any one of supplementary note 1 to supplementary note 4, further comprising
physical position detecting means for detecting a physical position of the target device based on a position sensor provided in the target device;
wherein the outputting means outputs the location result by adding the physical position to the location result.

### (Supplementary Note 7)

The information processing system according to supplementary note 4, wherein
the distance calculating means identifies, among the communication packets transmitted and received by the distance measurement device, the identifier included in communication packet of the communication by communication packets that the target device transmitted to the distance measurement device, and estimates the distance between the target device and the distance measurement device based on, among multiple communication packets that can be identified based on the identifier, the transmission timing at the distance measurement device of the communication packet transmitted by the distance measurement device, the reception timing at the distance measurement device of communication packet corresponding to a response to the communication packet, and speeds by which the communication packet flows in communication media through which the communication passes.

### (Supplementary Note 8)

The information processing system according to supplementary note 1, wherein
the acquiring means, the distance calculating means and the locating means are provided in the target device.

### (Supplementary Note 9)

The information processing system according to supplementary note 1, wherein
the acquiring means is provided in the target device, and
the distance calculating means and the locating means are provided in a control device communicably connected to the target device and the three or more distance measurement devices.

### (Supplementary Note 10)

A position location method comprising:
acquiring an address of each of three or more distance measurement devices to which a communication packet of a target device is to be transmitted;
calculating, for each of the three or more distance measurement devices, a distance between the target device and a distance measurement device based on the communication packet that the target device transmitted to the address of the distance measurement device;
generating a location result for predicting a located position of the target device based on positions of the three or more distance measurement devices and distances between the target device and the three or more distance measurement devices; and
outputting the location result.

### (Supplementary Note 11)

The position location method according to supplementary note 10, further comprising
detecting whether or not a proxy has been set for the target device, and
wherein the calculating the distance includes:
transmitting communication packet to each of the three or more distance measurement devices based on respective IP addresses of the three or more distance measurement devices;
if the proxy has not been set, estimating the distance between the target device and the distance measurement device by using, among the transmitted communication packets, a transmission timing of a SYN packet for establishing TCP connection and a reception timing of a SYN-ACK packet responding the SYN packet, and a position of the distance measurement device; and
if the proxy has been set, estimating the distance between the target device and the distance measurement device by using, among the transmitted communication packets, a transmission timing of a communication packet other than that for establishing TCP connection and a reception timing of communication packet responding the communication packet, and the position of the distance measurement device.

### (Supplementary Note 12)

The position location method according to supplementary note 10,
wherein the calculating the distance includes:
estimating, for each of the three or more distance measurement devices, the distance between the target device and the distance measurement device based on communication packets transmitted and received by the distance measurement device in communication by the communication packet transmitted by the target device to the distance measurement device.

### (Supplementary Note 13)

The position location method according to supplementary note 12, further comprising
inserting by the target device, into the communication packet, an identifier for identifying communication of the communication packet, and transmitting the communication packet, and
wherein the calculating the distance includes:
estimating, for each of the three or more distance measurement devices, the distance between the target device and the distance measurement device based on multiple communication packets identified based on the identifier transmitted and received by the distance measurement device.

### (Supplementary Note 14)

The position location method according to any one of supplementary note 10 to supplementary note 13, further comprising
acquiring Whois information based on an IP address indicated by the communication packet, and
wherein the outputting includes:
outputting the Whois information.

### (Supplementary Note 15)

The position location method according to any one of supplementary note 10 to supplementary note 13, further comprising
detecting a physical position of the target device based on a position sensor provided in the target device, and
wherein the outputting includes:
outputting the location result by adding the physical position to the location result.

### (Supplementary Note 16)

The position location method according to supplementary note 13,
wherein the calculating the distance includes:
identifying, among the communication packets transmitted and received by the distance measurement device, the identifier included in communication packet of the communication by communication packets that the target device transmitted to the distance measurement device, and estimating the distance between the target device and the distance measurement device based on, among the multiple communication packets that can be identified based on the identifier, the transmission timing at the distance measurement device of the communication packet transmitted by the distance measurement device, the reception timing at the distance measurement device of communication packet corresponding to a response to the communication packet, and speeds by which the communication packet flows in communication media through which the communication passes.

### (Supplementary Note 17)

A terminal device comprising:
acquiring means for acquiring an address of each of three or more distance measurement devices to which a communication packet is to be transmitted;
distance calculating means for calculating, for each of the three or more distance measurement devices, a distance between the target device and a distance measurement device based on the communication packet that the terminal device transmitted to the address of the distance measurement device;
locating means for generating a location result for predicting a located position of the target device based on positions of the three or more distance measurement devices and distances between the target device and the three or more distance measurement devices; and
outputting means for outputting the location result.

### (Supplementary Note 18)

The terminal device according to supplementary note 17, comprising
proxy setting detecting means for detecting whether or not a proxy has been set for the terminal device, wherein:
the distance calculating means transmits communication packet to each of the three or more distance measurement devices based on respective IP addresses of the three or more distance measurement devices;
the distance calculating means, if the proxy has not been set, estimates the distance between the target device and the distance measurement device by using, among transmitted communication packets, a transmission timing of a SYN packet for establishing TCP connection and a reception timing of a SYN-ACK packet responding the SYN packet, and a position of the distance measurement device; and
the distance calculating means, if the proxy has been set, estimates the distance between the target device and the distance measurement device by using, among transmitted communication packets, a transmission timing of a communication packet other than that for establishing TCP connection and a reception timing of communication packet responding the communication packet, and the position of the distance measurement device.

### (Supplementary Note 19)

An information processing system comprising
a target device, three or more distance measurement devices and a control device,
wherein the control device comprises:
distance calculating means for calculating, for each of three or more of the distance measurement devices, a distance between the target device and a distance measurement device based on a communication packet that the target device transmitted to the address of the distance measurement device;
locating means for generating a location result for predicting a located position of the target device based on positions of the three or more distance measurement devices and distances between the target device and the three or more distance measurement devices; and
outputting means for outputting the location result.

### (Supplementary Note 20)

The information processing system according to supplementary note 19, wherein
the distance calculating means estimates, for each of the three or more distance measurement devices, the distance between the target device and the distance measurement device based on communication packets transmitted and received by the distance measurement device in communication by the communication packet transmitted by the target device to distance measurement device.

### (Supplementary Note 21)

The information processing system according to supplementary note 20, wherein
the target device comprises notifying means for inserting, into the communication packet, an identifier for identifying communication of the communication packet, and for transmitting the communication packet;
the distance calculating means of the control device estimates, for each of the three or more distance measurement devices, the distance between the target device and the distance measurement device based on multiple communication packets transmitted and received by the distance measurement device identified based on the identifier.

While preferred example embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information processing system comprising:
one or more memories that store a set of instructions; and
one or more processors that individually or collectively are configured to execute the instructions to:
acquire an address of each of three or more distance measurement devices to which a communication packet of a target device is to be transmitted;
calculate, for each of the three or more distance measurement devices, a distance between the target device and a distance measurement device based on the communication packet that the target device transmitted to the address of the distance measurement device;
generate a location result for predicting a located position of the target device based on positions of the three or more distance measurement devices and distances between the target device and the three or more distance measurement devices; and
output the location result.

2. The information processing system according to claim 1,
wherein the one or more processors are further configured to execute the instructions to detect whether or not a proxy has been set for the target device,
wherein, in calculating the distance, the one or more processors are configured to execute the instructions to:
transmit communication packet to each of the three or more distance measurement devices based on respective IP addresses of the three or more distance measurement devices;
estimate, if the proxy has not been set, the distance between the target device and the distance measurement device by using, among transmitted communication packets, a transmission timing of a SYN packet for establishing TCP connection and a reception timing of a SYN-ACK packet responding the SYN packet, and a position of the distance measurement device; and
estimate, if the proxy has been set, the distance between the target device and the distance measurement device by using, among transmitted communication packets, a transmission timing of a communication packet other than that for establishing TCP connection and a reception timing of communication packet responding the communication packet, and the position of the distance measurement device.

3. The information processing system according to claim 1,
wherein, in calculating the distance, the one or more processors are configured to execute the instructions to:
estimate, for each of the three or more distance measurement devices, the distance between the target device and the distance measurement device based on communication packets transmitted and received by the distance measurement device in communication by the communication packet transmitted by the target device to the distance measurement device.

4. The information processing system according to claim 3, wherein
the one or more processors are further configured to execute the instructions to insert, by the target device, into the communication packet, an identifier for identifying communication of the communication packet, and transmit the communication packet, and
in calculating the distance, the one or more processors are configured to execute the instructions to estimate, for each of the three or more distance measurement devices, the distance between the target device and the distance measurement device based on multiple communication packets identified based on the identifier transmitted and received by the distance measurement device.

5. The information processing system according to claim 1, wherein
the one or more processors are further configured to execute the instructions to acquire Whois information based on an IP address indicated by the communication packet, and
in outputting, the one or more processors are configured to execute the instructions to output the Whois information.

6. The information processing system according to claim 1, wherein
the one or more processors are further configured to execute the instructions to detect a physical position of the target device based on a position sensor provided in the target device, and
in outputting, the one or more processors are configured to execute the instructions to output the location result by adding the physical position to the location result.

7. The information processing system according to claim 4,
wherein, in calculating the distance, the one or more processors are configured to execute the instructions to:
identify, among the communication packets transmitted and received by the distance measurement device, the identifier included in communication packet of the communication by communication packets that the target device transmitted to the distance measurement device, and estimate the distance between the target device and the distance measurement device based on, among multiple communication packets that can be identified based on the identifier, the transmission timing at the distance measurement device of the communication packet transmitted by the distance measurement device, the reception timing at the distance measurement device of communication packet corresponding to a response to the communication packet, and speeds by which the communication packet flows in communication media through which the communication passes.

8. The information processing system according to claim 1, wherein
the one or more processors of the target device are configured to execute the instructions to acquire the address, calculate the distance, and generate the location result.

9. The information processing system according to claim 1, wherein
the one or more processors of the target device are configured to execute the instructions to acquire the address, and
the one or more processors of a control device communicably connected to the target device and the three or more distance measurement devices, are configured to execute the instructions to calculate the distance, and generate the location result.

10. A position location method comprising:
acquiring an address of each of three or more distance measurement devices to which a communication packet of a target device is to be transmitted;
calculating, for each of the three or more distance measurement devices, a distance between the target device and a distance measurement device based on the communication packet that the target device transmitted to the address of the distance measurement device;
generating a location result for predicting a located position of the target device based on positions of the three or more distance measurement devices and distances between the target device and the three or more distance measurement devices; and
outputting the location result.

11. The position location method according to claim 10, further comprising
detecting whether or not a proxy has been set for the target device, and
wherein the calculating the distance includes:
transmitting communication packet to each of the three or more distance measurement devices based on respective IP addresses of the three or more distance measurement devices;
if the proxy has not been set, estimating the distance between the target device and the distance measurement device by using, among the transmitted communication packets, a transmission timing of a SYN packet for establishing TCP connection and a reception timing of a SYN-ACK packet responding the SYN packet, and a position of the distance measurement device; and
if the proxy has been set, estimating the distance between the target device and the distance measurement device by using, among the transmitted communication packets, a transmission timing of a communication packet other than that for establishing TCP connection and a reception timing of communication packet responding the communication packet, and the position of the distance measurement device.

12. The position location method according to claim 10,
wherein the calculating the distance includes:
estimating, for each of the three or more distance measurement devices, the distance between the target device and the distance measurement device based on communication packets transmitted and received by the distance measurement device in communication by the communication packet transmitted by the target device to the distance measurement device.

13. The position location method according to claim 12, further comprising
inserting by the target device, into the communication packet, an identifier for identifying communication of the communication packet, and transmitting the communication packet, and
wherein the calculating the distance includes:
estimating, for each of the three or more distance measurement devices, the distance between the target device and the distance measurement device based on multiple communication packets identified based on the identifier transmitted and received by the distance measurement device.

14. The position location method according to claim 10, further comprising
acquiring Whois information based on an IP address indicated by the communication packet, and
wherein the outputting includes:
outputting the Whois information.

15. The position location method according to claim 10, further comprising
detecting a physical position of the target device based on a position sensor provided in the target device, and
wherein the outputting includes:
outputting the location result by adding the physical position to the location result.

16. The position location method according to claim 13,
wherein the calculating the distance includes:
identifying, among the communication packets transmitted and received by the distance measurement device, the identifier included in communication packet of the communication by communication packets that the target device transmitted to the distance measurement device, and estimating the distance between the target device and the distance measurement device based on, among the multiple communication packets that can be identified based on the identifier, the transmission timing at the distance measurement device of the communication packet transmitted by the distance measurement device, the reception timing at the distance measurement device of communication packet corresponding to a response to the communication packet, and
speeds by which the communication packet flows in communication media through which the communication passes.

17. A terminal device comprising:
at least one memory configured to store instructions; and
at least one processor configured to execute the instructions to:
acquire an address of each of three or more distance measurement devices to which a communication packet is to be transmitted;
calculate, for each of the three or more distance measurement devices, a distance between the target device and a distance measurement device based on the communication packet that the terminal device transmitted to the address of the distance measurement device;
generate a location result for predicting a located position of the target device based on positions of the three or more distance measurement devices and distances between the target device and the three or more distance measurement devices; and
output the location result.

18. The terminal device according to claim 17, wherein
the at least one processor is further configured to execute the instructions to detect whether or not a proxy has been set for the terminal device, and
in calculating the distance, the at least one processor is configured to execute the instructions to:
transmit communication packet to each of the three or more distance measurement devices based on respective IP addresses of the three or more distance measurement devices;
estimate, if the proxy has not been set, the distance between the target device and the distance measurement device by using, among transmitted communication packets, a transmission timing of a SYN packet for establishing TCP connection and a reception timing of a SYN-ACK packet responding the SYN packet, and a position of the distance measurement device; and
estimate, if the proxy has been set, the distance between the target device and the distance measurement device by using, among transmitted communication packets, a transmission timing of a communication packet other than that for establishing TCP connection and a reception timing of communication packet responding the communication packet, and the position of the distance measurement device.
